(19) United States
(12) Patent Application Publication
(10) Pub. No.: US 2006/0045309 A1
(43) Pub. Date: Mar. 2, 2006

(54) Systems and methods for digital content security

(76) Inventor: Shan Suthaharan, Greensboro, NC (US)

Correspondence Address: KILPATRICK STOCKTON LLP, 1001 WEST FOURTH STREET, WINSTON-SALEM, NC, 27101, US

(21) Appl. No.: 11/152,121

(22) Filed: Jun. 14, 2005

Related U.S. Application Data
(60) Provisional application No. 60/579,951, filed on Jun. 14, 2004.

(51) Int. Cl. G06K 9/00

(52) U.S. Cl. 382/100

(57) ABSTRACT

The present invention provides systems and methods for digital content security. In one embodiment, a method includes generating an input key, generation of the input key comprising a sequence of operations, the operations including: performing at least one circular-bit-shift operation on a gradient image, and performing at least one block-wise permutation on the gradient image. One such method further includes performing a fragile watermark-embedding algorithm using the input key. Another such method includes utilizing the input key for encryption.

### CROSS-REFERENCE TO RELATED APPLICATIONS

This application claims priority to U.S. Provisional Patent Application Ser. No. 60/579,951, filed Jun. 14, 2004, titled “Encryption System,” the entirety of which is hereby incorporated by reference.

### FIELD OF THE INVENTION

The present invention relates to digital security. The present invention relates more particularly to systems and methods for digital content security.

### BACKGROUND OF THE INVENTION

Digital content are used in a vast array of applications. Digital content includes files, images, data structures and other content that can be created, transmitted, and manipulated by digital means.

Often, once created, digital content can be easily modified. For example, digital images are simple to create using conventional consumer and professional cameras, scanners, and even some cellular telephones. These digital images are also simple to tamper with. Powerful editing programs are available that allow users to alter digital images.

In an effort to detect when images have been tampered with, image authentication and tamper techniques have been developed. For example, a transparent watermark may be added to an image. Transparent watermarking involves distorting an image in a controlled manner and in a way that is minimally perceptible to humans.

One technique for transparent watermarking is fragile watermarking. A fragile watermark is a watermark that is destroyed if the image is manipulated, even slightly. Typically, a marking key and a watermark are used in a fragile watermarking process. The user receiving the image uses a detector to evaluate the authenticity of a received image. The detector must have the marking key and the watermark and may need additional information as well.

Over conventional techniques may be employed to secure other types of digital content. For example, files that are transmitted over the Internet are often encrypted to guard against. Various methods for encryption are well known to those of skill in the art.

### SUMMARY OF THE INVENTION

The present invention provides systems and methods for digital content security. In one embodiment, a method comprises generating an input key, generation of the input key comprising a sequence of operations, the operations comprising: performing at least one circular-bit-shift operation on a gradient image, and performing at least one block-wise permutation on the gradient image. One such method further comprises performing a fragile watermark-embedding algorithm using the input key. Another such method comprises utilizing the input key for encryption. In another embodiment, a computer-readable medium (such as, for example random access memory or a computer disk) comprises code for carrying out such methods.

This illustrative embodiment is mentioned not to limit or define the invention, but to provide one example to aid understanding thereof. Illustrative embodiments are discussed in the Detailed Description, and further description of the invention is provided there. Advantages offered by the various embodiments of the present invention may be further understood by examining this specification.

### BRIEF DESCRIPTION OF THE DRAWINGS AND ATTACHMENTS

These and other features, aspects, and advantages of the present invention are better understood when the following Detailed Description is read with reference to the accompanying drawings, wherein:

FIG. 1 is schematic of a key generation model in one embodiment of the present invention;

FIG. 2 shows sample block-wise permutated versions of the gradient image in one embodiment of the present invention;

FIG. 3 shows sample circularly-bit-shifted versions of the gradient image in one embodiment of the present invention;

FIG. 4 is an illustration of a block-wise permutated version of a noise image in one embodiment of the present invention;

FIG. 5 is an illustration of a circularly-bit-shifted version of a noise image in one embodiment of the present invention;

FIG. 6 is an illustration of a block-wise permutated version of a real image in one embodiment of the present invention;

FIG. 7 is an illustration of a circularly-bit-shifted version of a real image in one embodiment of the present invention; and

FIG. 8 is a schematic of a modified watermark embedding algorithm that includes the input key generated in one embodiment of the present invention.

### DETAILED DESCRIPTION OF THE INVENTION

Embodiments of the present invention comprise systems and methods for digital content security. There are multiple embodiments of the present invention. By way of introduction and example, one illustrative embodiment of the present invention provides a method for watermarking a digital image using a gradient image for key generation.

A series of circular-bit-shifts and block-wise permutations are performed on a gradient image to generate output images. The shifts are performed using a sequence (“sp”) of shift-bits values representing the number of bits to be shifted. The permutations are performed using a sequence (“pp”) of permutation-seed values, which generates pseudo-random block-wise permutations of the gradient image. The shift sequence and the permutation sequence are passed to the receiving user as a master key.

The output image is used as an input key for a watermarking algorithm. The watermarking algorithm utilizes the input key and a watermark to generate a watermarked image. When a user receives the watermarked image, the receiving user utilizes the master key, session key, gradient image, and watermark to authenticate the image. When the keys are applied to the gradient image to generate the input key and then applied to the watermarked image using the watermarking algorithm, the receiving user is able to view the watermark. If the watermark is destroyed or altered in any way, the receiving user knows that the watermarked image has been altered.

A session key is also provided to the receiving user. The session key comprises a bit string representing the sequence of circular-bit-shift and block-wise permutation operations performed on the gradient image to generate the input key. The master key may be passed once, but the session key is passed at the beginning of each session.

This introduction is given to introduce the reader to the general subject matter of the application. By no means is the invention limited to such subject matter. Illustrative embodiments are described below.

Embodiments of the present invention can be applied to image/video watermarking, data encryption, authentication and digital signatures. Embodiments of the present invention provide a secure key, which can be used to resist vector quantization (VQ) attack, random alteration, and cut and paste attacks on data.

One embodiment of the present invention provides a key generation algorithm for digital watermarking that improves localization, security, and key management. One such embodiment of the present invention is described below with reference to digital watermarking of image files. As will be understood by those of ordinary skill in the art, the methods and systems of the present invention may also be used with other types of data files or other digital content. Thus, the following description should be considered illustrative of an embodiment of the present invention and not limiting the scope of the invention in any sense.

The security of digital images is a concern for industries that provide commercial applications of digital images. Due to powerful editing software available in the market today, it is easy to tamper with digital images. Many fragile watermarking techniques for image authentication and tamper detection of digital images have emerged in recent years.

Generally, conventional fragile watermarking techniques are block-wise schemes designed to detect every possible change in the image's pixel values. The block-wise schemes generally suffer from three interrelated problems related to security, localization, and lack of key management.

In terms of security, a fragile watermarking scheme should provide high resistance to attacks, and if attacked, should have a high probability of detection. Unlike hackers of other data encryption schemes, the goal of an attacker in fragile watermarking is not to make the authentication watermark unreadable. Instead, the goal is to make changes to the protected image while preserving the watermark. The common attacks are vector quantization (“VQ”), random alterations and collage attack (i.e. cut and paste). For instance, a fragile watermarking scheme should detect if a user arbitrarily modifies a watermarked image, assuming that no watermark is present, such as, for example, by cropping the image or by replacing a portion of the image (e.g., replacing the face of a person in an image). A fragile watermarking scheme should also detect when an attacker attempts to modify an image without affecting the embedded watermark. A fragile watermarking scheme should also be able to detect when an attacker attempts to replace one watermark with another watermark.

In localization, any tamper should be detected with graceful localization ability. Localization refers to determining which areas of an image have been modified versus areas that have not.

Usually, additional keys are required to resist fragile watermarking attacks. This puts an additional burden on users to generate and maintain correct keys.

In order to increase resistance to attack, one embodiment makes the VQ codebook more difficult or impossible to build. Conventional methods aimed at achieving this exist. However, these existing schemes have two disadvantages related to localization: (1) when a block is tampered, tamper detection will show all blocks dependent on the tampered block as tampered, leading to false detection; and (2) when a big block is attacked by a collage or VQ attack, the detection results show the blocks surrounding the big block as tampered and the blocks within the big block as authentic, making it impossible to distinguish the tamper within the big block from the tamper surrounding the big block.

These problems occur because of the difficult nature of generating distinct input keys for different images as well as for different image blocks within the same image. In one embodiment of the present invention, a key image based fragile watermarking scheme thwarts random alterations, collage and VQ attacks while eliminating the localization problems associated with conventional methods.

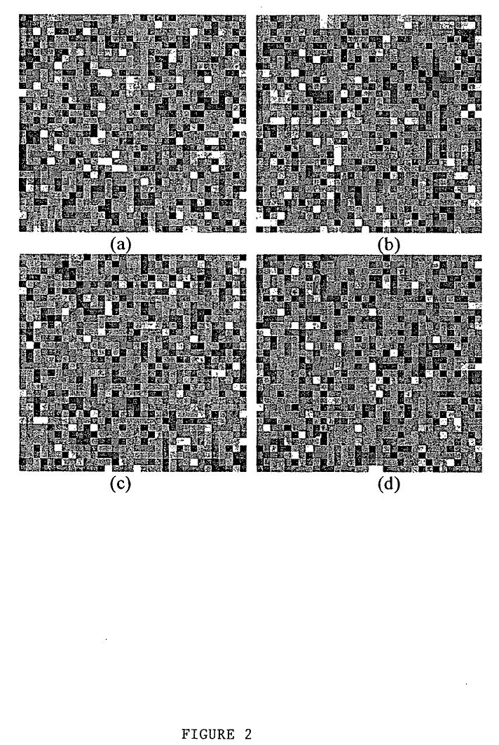

In one embodiment of an encryption method according to the present invention, a key image comprises an array of 256×256 pixels. Every 8×8 block of pixels in the key image provides distinct 512-bit sequences—a property that can be used to improve conventional fragile watermarking techniques. Two operations, a circular-bit-shift and a block-wise permutation, may be applied in any sequence to the key image to generate distinct images that can be used as input keys to a fragile watermarking scheme. The key image may comprise a gradient image, a noise image, or a real image. FIG. 2 is an illustration of block-wise permutated versions of a gradient image in one embodiment of the present invention.

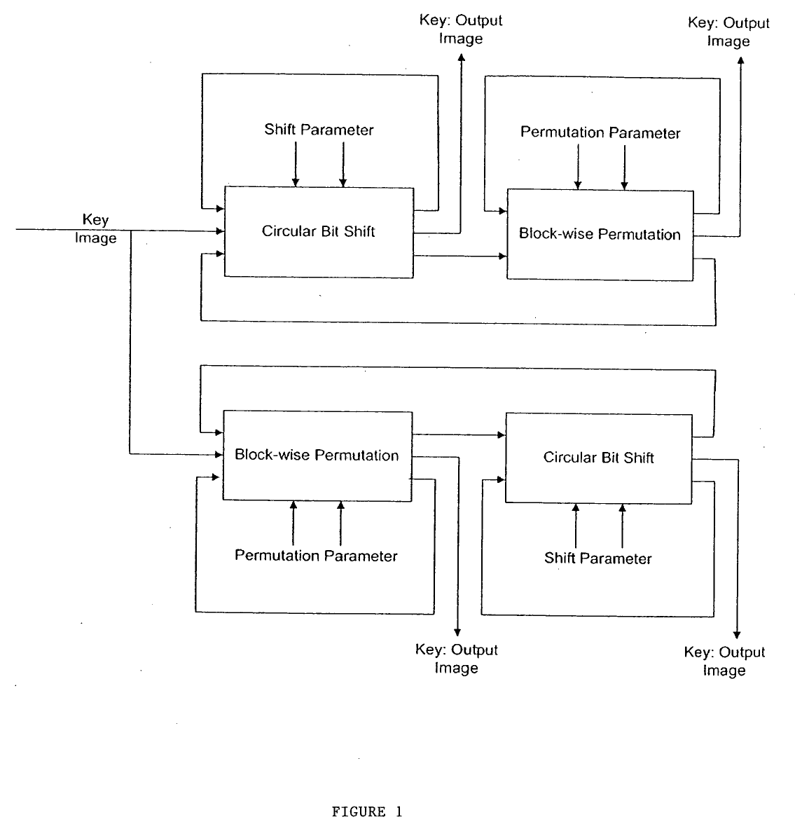

FIG. 1 is a block diagram illustrating a key image generator in one embodiment of the present invention. In the embodiment shown, a key image is input into a circular-bit-shift algorithm. A shift parameter (“sp”) is also input into the circular-bit-shift algorithm. The circular-bit-shift algorithm generates an output image. The output image may be used as the input image for another algorithm, such as a block-wise permutation or another circular-bit-shift. The block-wise permutation algorithm accepts the input image as well as a permutation parameter.

In one embodiment of the present invention, two keys are used for creation of the output image/input key. The two keys are a master key and a session key. The master key comprises the values of ss and sp utilized for each iteration of the algorithms shown in FIG. 1. The session key representation of the sequence of algorithms executed on the key image to generate the input key. These two keys are passed to the recipient of a watermarked image to allow the recipient to authenticate the image and ensure that it has not been tampered with.

Communicators need only exchange a master key the first time communication between them is established. However, embodiments of the present invention may be flexible, allowing users to exchange and update master keys at any time to increase security.

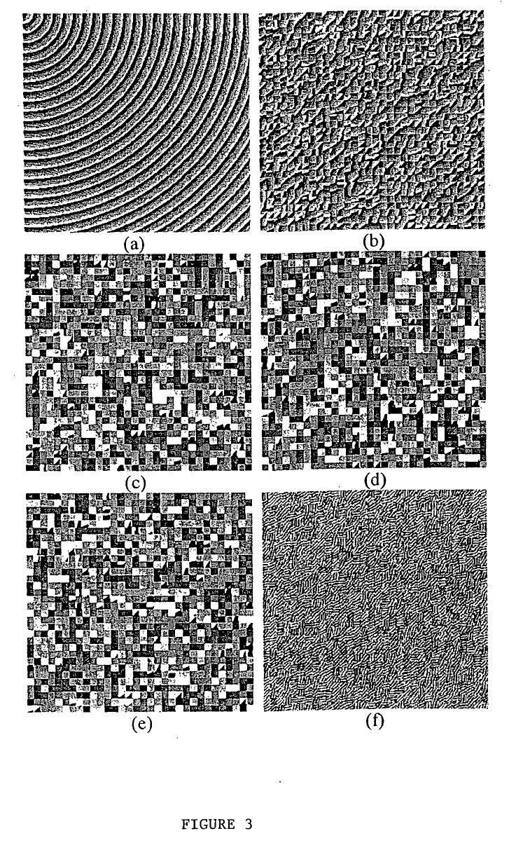

In one embodiment, the session key comprises a sequence of bits (0s and 1s), in which a 0 indicates a circular-bit-shift and a 1 indicates a block-wise permutation. The session key is of variable size and is generally exchanged at every session to determine different combinations of circular-bit-shift and block-wise permutation operations. For example, if the session key is 010110, the order in which the operations would be applied is circular shift→permutation→circular shift→permutation→permutation→circular shift. FIG. 3 is an illustration of images created using this generation sequence using sp=5, 5, and 5, and pp=122, 149, and 131 in one embodiment of the present invention.

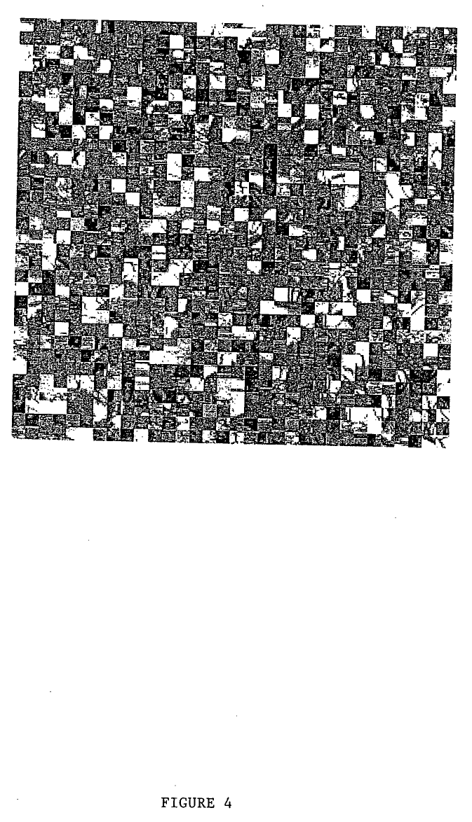

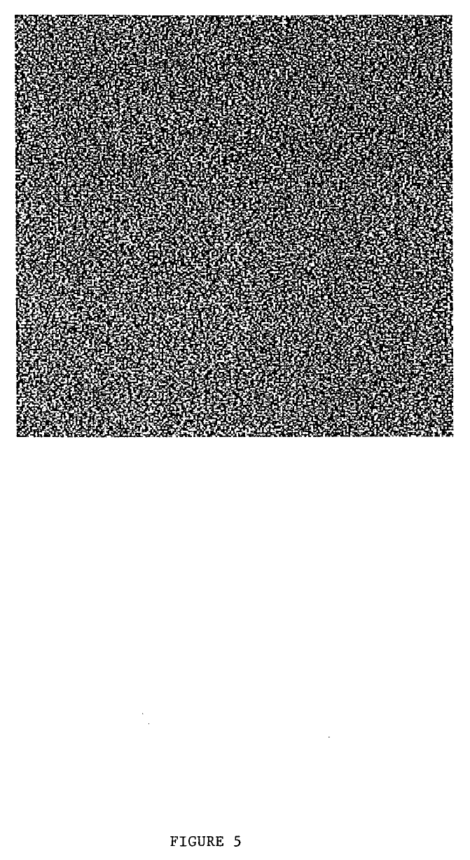

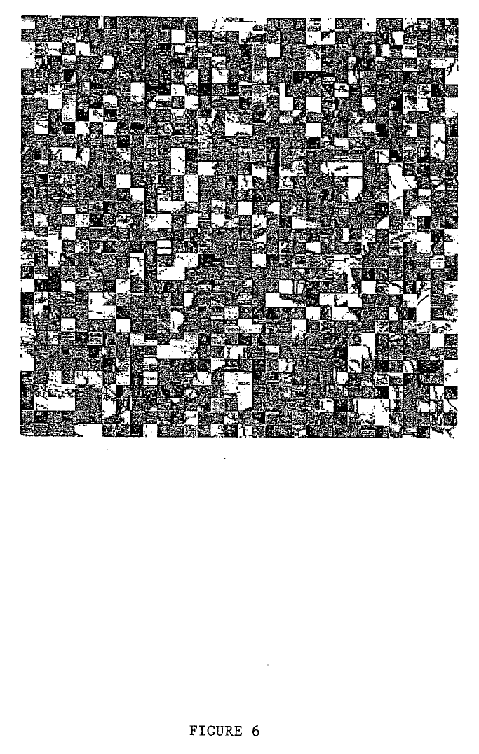

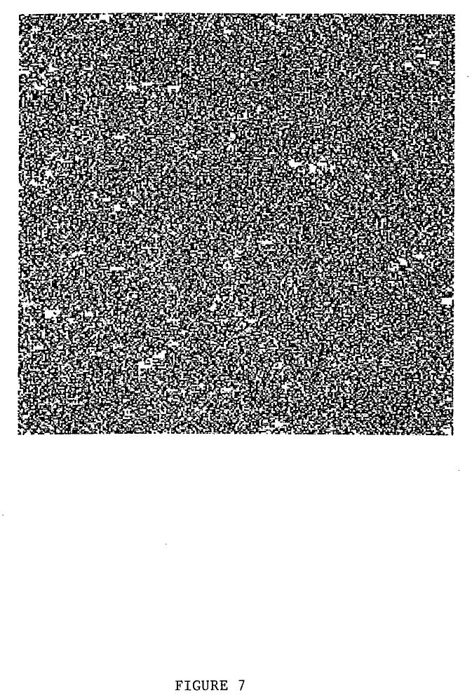

FIGS. 4 through 7 are illustrations of output images in various embodiments of the present invention. FIG. 4 is an illustration of a block-wise permutated version of a noise image in one embodiment of the present invention. FIG. 5 is an illustration of a circularly-bit-shifted version of a noise image in one embodiment of the present invention. FIG. 6 is an illustration of a block-wise permutated version of a real image in one embodiment of the present invention. And FIG. 7 is an illustration of a circularly-bit-shifted version of a real image in one embodiment of the present invention.

In one embodiment, the permutation operation is applied block-wise to the key image. The image is divided into 32×32 blocks of 8×8 pixels, giving 1024 distinct blocks. The block-wise permutation operation yields 1024! images.

In one embodiment, the circular-bit-shift operation is applied to the entire image. The key image is divided into 32×32 blocks of 8×8 pixels, and each block is represented as a 512-bit one-dimensional array. The bits are ordered from the most significant bit to the least significant bit of every pixel, from top to bottom and left to right over all the pixels in a block starting from the pixel at the top left hand corner of the block. However, an embodiment may allow different ordering by the users. Thus each block is a distinct 512-bit sequence, and the entire key image is a 2¹⁹ (512×32×32) bits sequence. Applying the circular-bit-shift operation yields the possibility of 2¹⁹ distinct images. In another embodiment, the circular-bit-shift operation is applied to portions of the entire image.

Different combinations of circular-bit-shift and block-wise permutation operations on the key image create a large key space of 2²⁰×1024! distinct images per key image. An image generated by this algorithm can be used as an input key to a fragile watermarking scheme. The key image has random influence on each image block. Due to the embedding algorithm, each block of the input key is different to every block in the image.

The generated input key has 32×32 blocks of 512 bits. Without knowing the bit sequence of the session key and the parameters of the master key, it is impossible for an attacker to generate the correct input key from the large key space of 2²⁰×1024! images, which cannot be stored for key search by the attacker. For example, if an attacker attempts to replace the block bᵢ by a similar block bᵢ′ (from the same image or from a different image), the new block bᵢ′ must have the same master key, session key, bit map logo, the same input key k, and the same input key block kᵢ. The cryptographic strength of the hash function, such as MD-5, which is used in most fragile watermarking schemes, shows that it is cryptographically infeasible to find similar image blocks where all of these conditions are satisfied.

Although embodiments of the present invention have been explained with reference to the bit sequence for image data, the present invention may be easily applied to other forms of data. In general, input data in computer systems are converted to a bit sequence before the transmission over computer networks.

In one embodiment of the present invention, the input key comprises a bit sequence of 2¹⁹ bits and is mapped to a session key of any size. For increased security, an input key may comprise a bit sequence of 32-bits or more for the session key to provide a better security especially when the key image is available to others.

Although described in terms of fragile watermarking, the input key may be used for other content security applications. For example, the input key may be used for encryption. The input key provides a large key to many cryptographic algorithms (such as Data Encryption Standards (DES) and Advanced Encryption Standard (AES)), message authentication codes and hash functions (such as MD-5 and SHA-1) for data encryption, authentication, message digest and digital signatures.

For example a large input key allows (i) one to select distinct keys that are needed for different rounds and different data blocks, for example in, DES and AES (ii) one to use different blocks for the plaintext to be encrypted and (iii) provides distinct keys for different blocks, which may have identical information (bit sequence). All these advantages are available with a small session key and its key management. Similarly, the hash functions (such as SHA-1) for message digest needs message of 512-bit blocks and this 2¹⁹ (512×32×32) bit key can be used to embed the message into it and use it with has functions to obtain a secure message digest.

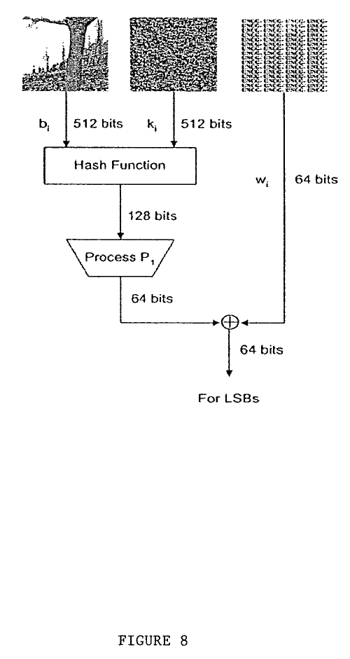

In one embodiment of the present invention, a watermark inserter embeds a watermark in an image. The watermark inserter may be implemented as a watermark-embedding algorithm. FIG. 8 is a schematic of a watermark-embedding algorithm that includes the input key generated in one embodiment of the present invention. In the embodiment shown in FIG. 8, an image to be watermarked and an input key, which is an image generated by a key generator, such as the key generator illustrated in FIG. 1, are input to a hash function. The hash function generates a 128-bit message digest (e.g., u₁, u₂, . . . u₁₂₈). The 128-bit message digest is then converted to a 64-bit sequence by process P₁, using the following XOR operations: v₁=u₁⊕u₆₅, v₂=u₂⊕u₆₆ . . . vᵢ=uᵢ⊕u₆₄₊₁ . . . v₆₄=u₆₄⊕u₁₂₈.

The watermark inserter then combines the 64-bit image digest of the watermark with the output of the process P₁, using an XOR function to generate the transparent watermark. The watermark is inserted into the least significant bit (“LSB”) of the pixels in the watermarked image. In another embodiment, the output of the hash function is converted to a 64-bit sequence and then input into an encryption routine.

Although the present invention has been described with reference to particular embodiments, it should be recognized that these embodiments are merely illustrative of the principles of the present invention. Those of ordinary skill in the art will readily envision variations, alternatives, and other uses of the present invention. Such variations, alternatives, and other uses are anticipated by this invention. Accordingly, the description herein should not be read as limiting the present invention, as other embodiments also fall within the scope of the present invention.

That which is claimed:

1. A method for digital watermarking comprising:
generating an input key, generation of the input key comprising a sequence of operations, the operations comprising:
performing at least one circular-bit-shift operation on a gradient image, and
performing at least one block-wise permutation on the gradient image; and
performing a fragile watermark-embedding algorithm using the input key.

2. The method of claim 1, further comprising generating a master key representing the sequence of operations

3. The method of claim 2, wherein the master key comprises a sequence of 0s and 1s.

4. The method of claim 3, wherein each 0 represents a circular-bit-shift and each 1 represents a block-wise permutation.

5. The method of claim 1, wherein the at least one circular-bit-shift operation comprises a plurality of circular-bit-shift operations.

6. The method of claim 1, wherein the at least one block-wise permutation comprises a plurality of block-wise permutations.

7. The method of claim 1, wherein the at least one circular-bit-shift operation is performed before the at least one block-wise permutation.

8. The method of claim 1, wherein the at least one block-wise permutation is performed before the at least one circular-bit-shift operation.

9. The method of claim 1, wherein the sequence of operations, comprises:
performing a first of the at least one circular-bit-shift operation;
performing a first of the at least one block-wise permutation;
performing a second of the at least one circular-bit-shift operation;
performing a second of the at least one block-wise permutation;
performing a third of the at least one block-wise permutation; and
performing a third of the at least one circular-bit-shift operation.

10. The method of claim 1, wherein the gradient image comprises 256×256 pixels.

11. The method of claim 10, wherein performing the at least one block-wise permutation comprises:
dividing the gradient image into 32×32 image blocks of 8×8 pixels; and
applying the block-wise permutation to each of the 32×32 image blocks.

12. The method of claim 10, wherein performing the at least one circular-bit-shift operation comprises:
dividing the gradient image into 32×32 image blocks of 8×8 pixels; and
generating an identification array for each of the 32×32 image blocks, the identification array comprising 512 bits, the 512 bits ordered from a most significant bit to a least significant bit for each of the 8×8 pixels.

13. A method comprising:
generating an input key, generation of the input key comprising a sequence of operations, the operations comprising:
performing at least one circular-bit-shift operation on a gradient image, and
performing at least one block-wise permutation on the gradient image; and
encrypting digital content utilizing the input key.

14. A computer-readable medium on which is encoded program code, the program code comprising:
program code for generating an input key, generation of the input key comprising a sequence of operations, the operations comprising:
program code for performing at least one circular-bit-shift operation on a gradient image, and
program code for performing at least one block-wise permutation on the gradient image; and
program code for performing a fragile watermark-embedding algorithm using the input key.

15. A computer-readable medium on which is encoded program code, the program code comprising:
program code for generating an input key, generation of the input key comprising a sequence of operations, the operations comprising:
program code for performing at least one circular-bit-shift operation on a gradient image, and
program code for performing at least one block-wise permutation on the gradient image; and
program code for encrypting digital content utilizing the input key.
